(19) United States
(12) Patent Application Publication
(10) Pub. No.: US 2017/0271729 A1
(43) Pub. Date: Sep. 21, 2017

(54) TEMPERATURE CONTROL DEVICE

(71) Applicant: Mahle International GmbH, Stuttgart (DE)

(72) Inventors: Stefan HIRSCH, Stuttgart (DE); Juergen GRUENWALD, Ludwigsburg (DE); Joachim TREIER, Oppenau (DE)

(21) Appl. No.: 15/507,184

(22) PCT Filed: Jul. 30, 2015
(86) PCT No.: PCT/EP2015/067576

§ 371 Date: Feb. 27, 2017

(30) Foreign Application Priority Data
Aug. 29, 2014 (DE) 10 2014 217 338.8

(51) Int. Cl. H01M 10/6572; F25B 41/04; H01M 10/625; F25B 21/04; H01M 10/48; H01M 10/6556

(52) U.S. Cl. CPC H01M 10/6572; H01M 10/486; H01M 10/6556; H01M 10/625; F25B 21/04; F25B 41/04; H01M 2220/20; F25B 2321/023; F25B 2321/025

(57) ABSTRACT

A temperature control device may include a temperature control structure through which a fluid is flowable and which may have at least one first conduit wall defining an interior, and at least one thermoelectric module arranged on the first conduit wall on a side facing away from the interior. The thermoelectric module may have at least two element rows, each having at least two thermoelectric elements. The element rows may extend along an extension direction. At least two fluid channels may be provided in the temperature control structure, one fluid channel for each element row such that each fluid channel may be thermally coupled to an associated element row. In at least one fluid channel, a valve may be provided, the valve being adjustable between a closed position, in which the valve may close the fluid channel, and an open position, in which the valve may release the fluid channel.

### CROSS REFERENCE TO RELATED APPLICATIONS

This application claims priority to German Patent Application No. DE 10 2014 217 338.8, filed Aug. 29, 2014, and International Patent Application No. PCT/EP2015/067576, filed Jul. 30, 2015, both of which are hereby incorporated by reference in their entirety.

### TECHNICAL FIELD

The invention relates to a temperature control device and a battery arrangement with such a temperature control device.

### BACKGROUND

In modern hybrid and electric motor vehicles, lithium-ion batteries often come into use as rechargeable energy stores. A battery which is optimized with regard to lifespan and maximum energy storage amount requires, for the individual battery cells, a correspondingly efficient temperature control device, which in particular is able to prevent a heating of the battery beyond a maximum operating temperature.

Against this background, active temperature control devices are known from the prior art, which comprise a temperature control structure through which a temperature control medium in the form of a fluid can flow. Such a temperature control structure typically has two temperature control plates delimiting a fluid channel. Said temperature control structure acts as a heat source or heat sink and permits a heat exchange between the battery which is to be temperature-controlled and the fluid flowing through the temperature control structure. The heat exchange can be supported by thermoelectric elements in the form of so-called Peltier elements, which are arranged at defined locations between the battery which is to be temperature-controlled and the temperature control plates.

For example, DE 10 2012 211 259 A1, which describes such a temperature control device, is known from the prior art.

It proves to be a problem in such temperature control devices, in the individual battery cells of a battery which is thermally coupled to the temperature control device, to achieve as homogeneous a temperature control as possible of all these battery cells.

It is therefore an object of the present invention to create an improved embodiment of a temperature control device, which enables as homogeneous a temperature control as possible of all the battery cells of a battery which is thermally coupled to the temperature control device. Furthermore, it is an object of the present invention to create a battery arrangement with such a temperature control device.

These problems are solved by the subject of the independent claims. Preferred embodiments are the subject of the dependent claims.

### SUMMARY

A basic idea of the invention is accordingly to equip a temperature control structure on the one hand with at least two element rows of thermoelectric elements, and on the other hand with fluid channels through which a fluid can flow. A temperature control structure according to the invention is designed here in such a way that a fluid channel is associated with each element row with its thermoelectric elements. The association is realized here in such a way that the thermoelectric elements of a particular element row are arranged in the temperature control structure in such a way that they are coupled thermally to the fluid channel associated therewith. This has the result that the temperature control effect brought about by a fluid channel and by the fluid flowing through the latter can be supported by these at least two thermoelectric elements—these typically follow the operating principle of conventional Peltier elements—of a particular element row.

Furthermore essential to the invention is a valve element, provided in at least one fluid channel, which valve element is adjustable between a closed position, in which it closes the fluid channel, and an open position, in which it releases the fluid channel in order for the fluid to flow through. This permits the temperature control effect brought about by means of the respective fluid channel to also be varied in a flexible manner. When the fluid flowing through the fluid channel is, for instance, a coolant, then by a closing of the fluid channel by means of the valve element, the cooling effect generated by the fluid can be reduced locally in the region of this fluid channel, because in this case, only the thermoelectric elements associated with the closed fluid channel contribute to the cooling effect. In contrast, through an adjustment of the valve element into its open position, the cooling power provided by the coolant flowing through the fluid channel is maximized.

Such a “switching on and off” of a fluid channel makes it possible to react to so-called “hotspots” in the battery cells which are to be cooled. These are to be understood to mean local housing zones of the battery cell which is to be temperature-controlled, with locally increased or reduced temperature with respect to the remaining housing parts.

The concept of fluid channels presented here, with a fluid through-flow quantity which is adjustable via a valve element, develops its advantageous effect therefore to a considerable extent when not only one single fluid channel, but rather at least two, preferably all available fluid channels are equipped with such an adjustable valve element.

A temperature control device according to the invention for controlling the temperature of at least one, in particular electrochemical, energy supply unit in the form of a battery cell of a battery comprises a temperature control structure through which a fluid can flow, the interior of which is delimited by at least one conduit wall. Typically, such a temperature control structure can be constructed in the manner of a pipe, for instance in the manner of a flat pipe, the pipe walls of which delimit the interior of the temperature control structure. Furthermore, the temperature control device comprises at least one thermoelectric module, which on a side facing away from the interior of the temperature control structure is arranged on the conduit wall of the temperature control structure. The thermoelectric module has a first and at least one second element row with respectively at least two thermoelectric elements, wherein the at least two element rows extend respectively along an extension direction. These element rows, formed from thermoelectric elements, undertake the function of conventional Peltier elements.

According to the invention, a fluid channel is arranged in the temperature control structure for each element row, in such a way that each fluid channel is thermally coupled to an element row which is associated with it. In the simplest case of a thermoelectric module with only two element rows, accordingly two fluidically separated fluid channels are formed in the interior of the temperature control structure, through which fluid channels respectively a fluid can flow. Here, a valve element is provided in at least one fluid channel, which valve element is adjustable between a closed position, in which it closes the fluid channel, and an open position, in which it releases the fluid channel in order for the fluid to flow through. Preferably, such a valve element is present in both fluid channels, particularly preferably—when more than two fluid channels are provided in the temperature control structure—in all available fluid channels.

In a preferred embodiment, in the element row which is associated with the fluid channel having a valve element, an electric actuator element can be provided, cooperating with the valve element, which actuator element is electrically connected with the at least two thermoelectric elements of this element row. The electric actuator element has two operating states here and cooperates with the valve element in such a way that in a first operating state it adjusts the valve element into the open state, and in a second operating state adjusts it into the closed state, or vice versa. Such a configuration of the valve element allows the functionality of the thermoelectric elements of a particular element row to be coupled to the valve element of the fluid channel associated with this element row. Therefore, the heating- or cooling power generated by the thermoelectric elements can be coupled with the heating- or respectively cooling power generated by the fluid flowing through the fluid channel.

In an advantageous further development, the electric actuator element can be connected electrically in series to the at least two thermoelectric elements. According to this variant, the electric actuator element comprises an electric coil element, which in the first operating state of the actuator element is flowed through by electric current, but not in the second operating state. In the first operating state, therefore, a magnetic field can be generated by the electric current flowing through the electric coil element, which field—with suitable technical realization of the valve element—is able to bring about, through interaction with the valve element, its adjustment between the open and the closed position.

Particularly expediently, the electric actuator element can be constructed in such a way that it cooperates with the valve element in a contactless manner for adjusting between the open and the closed position. This may take place for instance via the already mentioned magnetic coupling, when the valve element is provided with a magnetic component, for instance a magnetized member, which can interact with the magnetic field generated by the electric coil element.

In a preferred embodiment, the valve element can comprise a spring-elastic element, in particular a leaf spring, which is prestressed against the open or against the closed position. Such a spring-elastic element is composed very simply in construction and takes up only a small amount of installation space, so that it can be installed in the temperature control structure in a space-saving manner. Furthermore, such a spring-elastic element is also able to be produced in a cost-efficient manner, which leads overall to reduced manufacturing costs of the entire temperature control device, in particular when a plurality of such spring-elastic elements are to be installed. The prestressing of the spring-elastic element, proposed here, against the open or closed position, furthermore allows an operating principle to be realized which is familiar to the specialist in the art as a “fail-safe function”.

Alternatively to the construction as a spring-elastic element, a realization in the form of a so-called microvalve is also conceivable for the valve element.

A geometrically particularly compact structure of the temperature control device can be achieved in another preferred embodiment, according to which the thermoelectric elements of an element row are arranged substantially in a straight line along a longitudinal direction, and the at least two element rows are arranged adjacently to one another along a transverse direction running transversely to the longitudinal direction. Furthermore, the thermoelectric elements of the thermoelectric module are arranged along a vertical direction, which runs orthogonally to the longitudinal direction and to the transverse direction, between a first electrically insulating insulation element and a second electrically insulating insulation element. The second electrically insulating insulation element is arranged here in vertical direction between the thermoelectric elements and the conduit wall of the temperature control structure. Such an arrangement geometry enables an improved thermal contact of the thermoelectric module with the battery cell which is to be temperature-controlled, in particular when this has a flat housing wall. This can then be brought to lie in a planar manner mechanically against the thermoelectric module. As a result, a particularly good thermal contact occurs between the element rows and the fluid channels associated with these element rows with the battery cell which is to be temperature-controlled.

Particularly expediently, the temperature control structure can be constructed as a flat pipe, in which the at least two fluid channels are provided, and which lies with a side facing the thermoelectric module in a planar manner against the latter. This leads to a thermal contact, over a large area, of the fluid channels of the flat pipe with the thermoelectric module, with, at the same time, a small installation space requirement. In this variant, the at least two fluid channels extend respectively along the already established extension direction. With regard to the likewise already established vertical direction, which runs orthogonally both to the extension direction and also to the transverse direction, each fluid channel therefore runs at a distance from the element row associated with it and substantially parallel thereto.

In another preferred embodiment, which permits a particularly simple electrical wiring of the thermoelectric elements of the element rows, thermoelectric elements of the first element row are electrically connected to one another in series for the formation of a first electric line branch, and the at least two thermoelectric elements of the second element row are electrically connected to one another in series for the formation of a second electric line branch. Such an electric series connection may take place for instance through suitable jumpers, for example in the manner of copper bridges, through which adjacent thermoelectric elements of an element row are electrically connected to one another.

In an advantageous further development of the invention, in at least one element row, preferably in each element row, which is associated with a fluid channel with a valve element, an electric switching element can be provided, which is able to be switched between a closed state and an open state. The electric switching element is electrically connected in series to the electric actuator element and to the at least two thermoelectric elements of the associated element row. This has the result that in the closed state of the switching element, an electric current provided by an external energy source can flow through the thermoelectric elements, so that these act as Peltier elements and can contribute to the temperature control of the battery cell.

The electric actuator element and the electric switching element, connected electrically thereto in series, can be configured in such a way that a switching of the electric switching element into the closed state brings about a switching of the electric actuator element into the first operating state, and a switching of the electric switching element into the open state brings about a switching of the electric actuator element into the second operating state. A switching of the actuator element into the first operating state, however, as already explained, has the result that the associated valve element is adjusted into the open state, so that the respective fluid channel is released in order to for the fluid to flow through. Consequently, the fluid flowing through the fluid channel can also contribute to the temperature control of the battery cell. Vice versa, a switching of the electric switching element into the open state brings about an interruption of the electric current flow through the respective element row, so that the thermoelectric elements can not then contribute to the temperature control of the battery cell. In this case, through the accompanying switching of the actuator element into the second operating state, however, it is also brought about simultaneously that the respective fluid channel is closed. Therefore, the fluid can no longer flow through the respective fluid channel and consequently also can no longer contribute to the temperature control of the battery cell. The aforegoing presented configuration therefore permits the temperature control effect, achieved by the thermoelectric elements of a particular element row, to be coupled with that of the fluid which flows through the fluid channel associated with the element row.

Particularly expediently, the electric switching element can comprise a semiconductor switch, in particular a thyristor. This enables the particularly simple activation of such a semiconductor switch by an electronic control/regulation unit. The use of a thyristor is to be recommended, because the latter is suitable to a particular extent for controlling high electric currents, such as are necessary for the operation of thermoelectric elements.

In a particularly preferred embodiment, the thermoelectric module can comprise at least one temperature sensor for measuring the temperature of a battery cell which is thermally coupled to the thermoelectric module. Furthermore, the temperature control device comprises a control/regulation unit cooperating with the first and/or with the second electric switching element and with the at least one temperature sensor. The control/regulation unit is arranged in such a way that it switches the first and/or the at least one second electric switching element, as a function of the temperature measured by the temperature sensor, between the open and the closed state. The temperature sensor therefore permits, in connection with the control/regulation unit, a regulation of the heating- or respectively cooling power, provided by the thermoelectric elements arranged in the line branches, as a function of the temperature of the battery cell coupled to these thermoelectric elements. This leads to an improved and particularly homogeneous temperature control of the battery cell. Through the coupling, realized by means of the actuator elements, with the valve element of the fluid channels, in addition the temperature control effect generated by the fluid flowing through the fluid channels is also regulated.

According to a particularly preferred embodiment, for at least one element row, preferably for all element rows, an individual temperature sensor can be provided for measuring the temperature of a battery cell which is thermally coupled to the respective element row of the thermoelectric module. Preferably, at least two temperature sensors, particularly preferably a plurality of temperature sensors, can be provided in an element row. In this embodiment, the temperature control device is furthermore also constructed in such a way that the electric switching element, associated with a particular element row, is activated by the control/regulation unit as a function of the temperature which is determined by the temperature sensor(s) associated with it. In this way, an individual regulation of the individual element rows can be realized. This opens up the possibility of controlling the temperature of local zones of the battery cell individually. Thereby, the possible formation of the already mentioned “hotspots” can be reacted to particularly well.

In another preferred embodiment, the temperature sensor can be constructed as an infrared sensor, by means of which the infrared radiation emitted by the battery cell is able to be measured for determining temperature.

In a further preferred embodiment, the electric switching element can be provided on a side of the thermoelectric module facing the temperature control structure. In this way, it can be prevented that waste heat, generated by the switching element during normal operation, disturbs the temperature control of the battery cell.

In a further preferred embodiment, the actuator element is arranged electrically between two thermoelectric elements. In this way, the required installation space for accommodating the respective actuator element can be kept small.

Particularly expediently, the valve element can be arranged, in particular along the extension direction, in the region of an actuator element. In this way, the desired coupling between valve element and actuator element can be realized particularly effectively.

Particularly preferably, the electric switching element can also be arranged electrically between two thermoelectric elements. In this way, the electric wiring outlay for the thermoelectric elements can be kept small.

The invention further relates to a battery arrangement with a previously presented thermoelectric device. The battery arrangement further comprises a battery having at least one battery cell. The at least one battery cell is arranged here on a side of the thermoelectric module, on the latter, which side faces away from the temperature control structure. In this way, an effective thermal coupling of the at least one battery cell can be achieved both to the thermoelectric module and also to the temperature control structure of the temperature control device.

In a particularly preferred embodiment, an individual thermoelectric module can be provided for each battery cell which is to be temperature-controlled. By means of such a modular structure of the thermoelectric device, the latter can be used in a flexible manner for the temperature control of basically any number of battery cells. According to this embodiment, the battery arrangement therefore comprises a first and at least one second thermoelectric module. Accordingly, the battery which is to be temperature-controlled comprises a first and at least one second battery cell. For thermal coupling to the respective thermoelectric module, a housing wall of the housing of a respective battery cell can be coupled mechanically and therefore also thermally to the respective thermoelectric module and, via the latter, to the temperature control structure.

As already mentioned, the modular concept presented above permits the temperature control of a battery with basically any desired number of battery cells. In a preferred embodiment of the battery arrangement presented here, said battery therefore comprises a plurality of battery cells, wherein for each battery cell respectively precisely one thermoelectric module is provided, which is connected mechanically and therefore also thermally to this battery cell.

According to a particularly advantageous embodiment of the battery arrangement presented here, for each pair of a battery cell and a thermoelectric module respectively at least one individual temperature sensor can be provided. This, with the use of the common control/regulation unit presented above, enables an individual temperature control of the individual battery cells by the thermoelectric module associated with them.

In an advantageous further development, the construction is recommended of the control/regulation unit in such a way that the latter switches between their closed and open state the electric switching elements of a respective thermoelectric module as a function of the temperature, which is able to be determined by the at least one temperature sensor associated with this module. This permits an individual switching on and off of the corresponding element rows and fluid channels as a function of the measured temperature.

In another preferred embodiment, an electrically insulating adapter layer of a heat-conducting material, in particular of an adhesive, can be provided between the at least one battery cell and the thermoelectric module, on which layer lie both the at least one battery cell for heat transmission and also the thermoelectric module for thermal coupling of the at least one battery cell to the thermoelectric module. In this way, undesired intermediate spaces can be prevented between the housing of the battery cell which is to be temperature-controlled and the thermoelectric module, which typically involve a reduced thermal coupling.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained in further detail in the following description, wherein the same reference numbers refer to identical or similar or functionally identical components.

### BRIEF DESCRIPTION OF THE DRAWINGS

There are shown, respectively diagrammatically

FIG. 1 an example of a temperature control device according to the invention for controlling temperature, in a longitudinal section,

FIG. 2 the temperature control device of FIG. 1 in a cross-section along the section line II-II in FIG. 1,

FIG. 3 the temperature control device of FIG. 1 in a cross-section along the section line III-III of FIG. 2,

FIG. 4 a battery arrangement according to the invention, with twelve to be temperature-controlled 4, in a cross-section along the section line IV-IV of FIG. 5,

FIG. 5 the battery arrangement 24 of FIG. 4 in a cross-section along the section line V-V of FIG. 4,

FIG. 6 a detail illustration of FIG. 4 in the region of three adjacent battery cells or respectively three adjacent thermoelectric modules.

### DETAILED DESCRIPTION

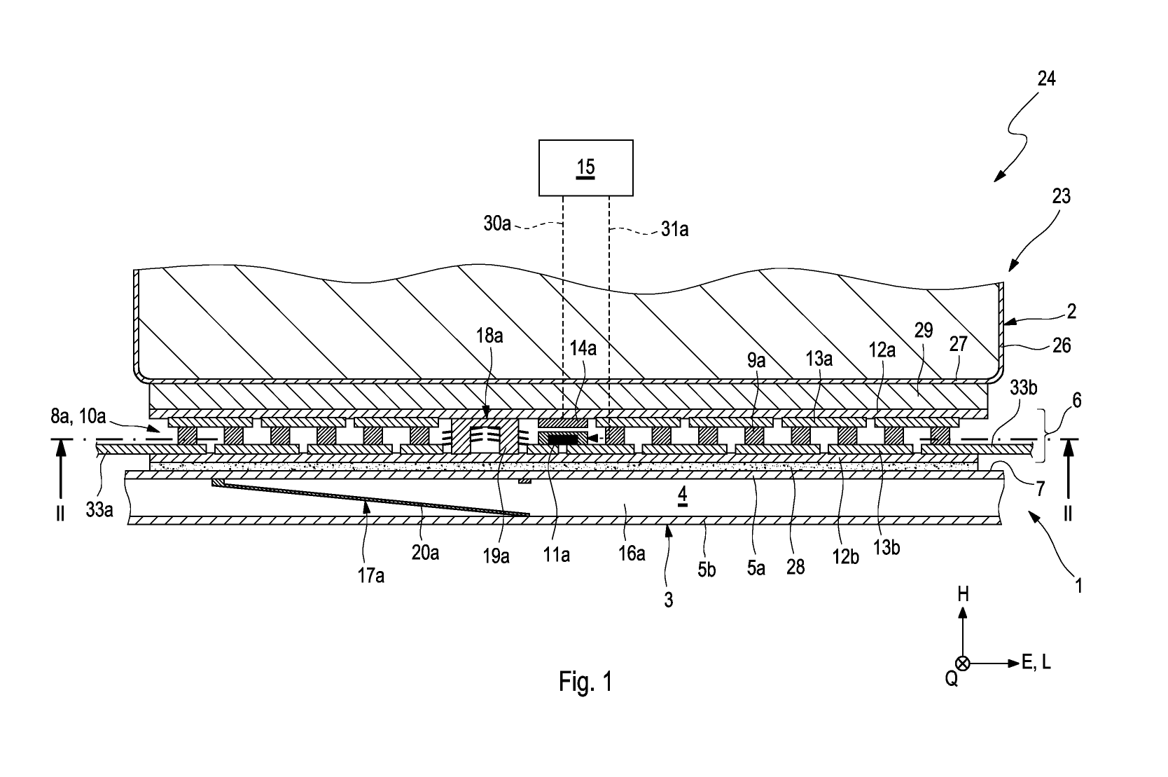

FIG. 1 illustrates an example of a temperature control device 1 according to the invention for temperature control, in a longitudinal section. The temperature control device 1 serves for controlling the temperature of at least one electrochemical energy supply unit in the form of a battery 23 with at least one battery cell 2. The temperature control device 1 comprises a temperature control structure 3 through which a fluid can flow, the interior 4 of which is delimited by a first and second conduit wall 5a, 5b. In the example of FIG. 1, the conduit walls 5a, 5b lie opposite one another. The temperature control device 1 further comprises a thermoelectric module 6, which is arranged on a side 7 on the first conduit wall 5a of the temperature control structure 3 facing away from the interior 4 of the temperature control structure 3. The thermoelectric module 6 can be fastened to the temperature control structure 3 by means of a contact layer 28 of a thermally conductive adhesive.

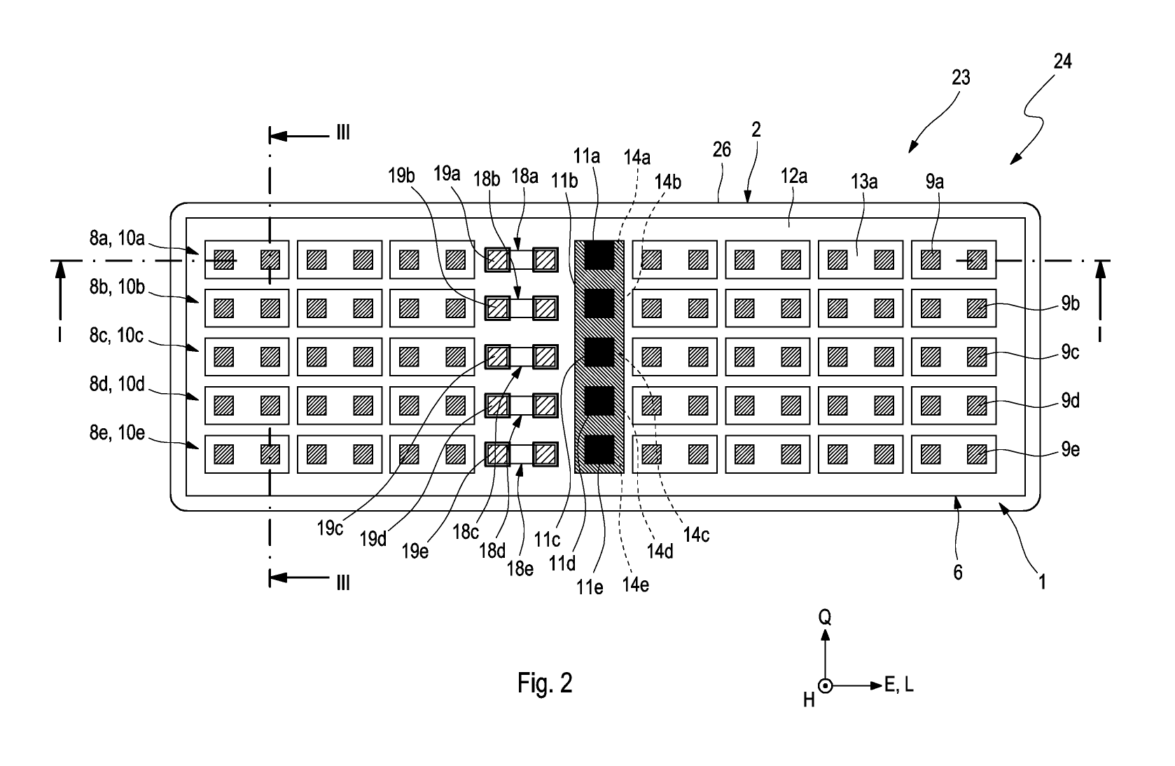

FIG. 2 shows the temperature control device 1 of FIG. 1 in a cross-section along the section line II-II of FIG. 1. It can be seen that the thermoelectric module 6 in the example has five element rows 8a-8e with respectively several thermoelectric elements 9a-9e. The structure of the thermoelectric elements 9a-9e, which comprise a thermoelectrically active material, is known to the relevant specialist in the art, so that the thermoelectric elements 9a-9e are only sketched roughly diagrammatically in FIGS. 1 and 2.

The individual element rows 8a-8e extend respectively along a shared extension direction E. The thermoelectric elements 9a-9e of each element row 8a-8e are connected electrically to one another in series for the formation of a respective electric line branch 10a-10e. In other words, the thermoelectric elements 9a of the first element row 8a form a first electric line branch 10a, the thermoelectric elements 9b of the second element row 8b form a second electric line branch 10b etc.

The individual element rows 8a-8e or respectively line branches 10a-10e can be electrically connected to one another in a parallel manner by means of electric connecting elements 33a, 33b, as shown in FIG. 1. Via the electric connecting elements 33a, 33b, the element rows 8a-8e can be electrically connected to an external electrical energy course (not shown). It can be seen from FIG. 2 that the thermoelectric elements 9a-9e of each element row 8a-8e are arranged substantially in a straight line along a longitudinal direction L and adjacent to one another with respect to a transverse direction Q running orthogonally to the longitudinal direction. In the example of the figures, the extension direction E is identical to the longitudinal direction L. With a non-rectilinear construction of an element row 8a-8e, the extension direction E can, however, also vary along the element row 8a-8e.

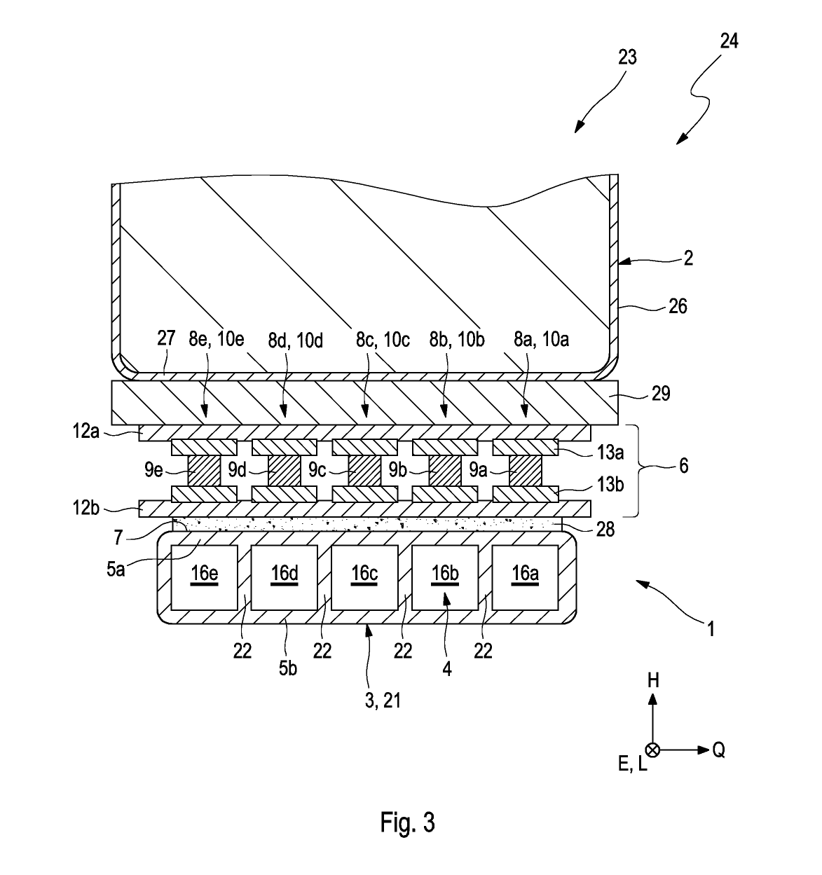

According to FIG. 1, an individual fluid channel 16a-16e is provided in the interior 4 of the temperature control structure 3 for each element row 8a-8e. In the sectional illustration of FIG. 1, only the fluid channel 16a and the element row 8a associated with this channel 16a are shown. FIG. 3, on the other hand, shows the temperature control device 1 in a cross-section along the section line III-III of FIG. 2. In this view, the five element rows 8a-8e and five associated fluid channels 16a-16e can be seen. The arrangement of the fluid channels 16a-16e in the temperature control structure 3 relative to the element row 8a-8e takes place according to FIG. 3 such that each fluid channel 16a-16e is thermally coupled to an element row 8a-8e associated with it.

Observing now FIG. 1 again, it can be seen that in the first element row 10a, shown in FIG. 1, a first electric switching element 11a is provided, which is connected electrically in series to the thermoelectric elements 9a. Such electric switching elements 11b to 11e can also—as illustrated in FIG. 2—be provided in the other element rows 8b-8e. In simplified variants of the example, only individual element rows 8a-8e are equipped with an electric switching element 11a-11e.

The electric switching elements 11a-11e able to be switched respectively between a closed and an open state, i.e. the electric switching elements 11a-11e following the operating principle of an electric switch. In the closed state, the thermoelectric elements 9a-9e of the associated element row 8a-8e can be flowed through by an electric current from an external energy source (not shown); in the open state, this is not possible.

FIG. 1 shows that the thermoelectric elements 9a-9e of each element row 8a-8e, along a vertical direction H which runs orthogonally to the longitudinal direction L and to the transverse direction Q, are arranged in a sandwich-like manner between a first electrically insulating insulation element 12a and a second electrically insulating insulation element 12b. Here, the second insulation element 12b is arranged in vertical direction H between the thermoelectric elements 9a-9e and the first conduit wall 5a of the temperature control structure 3.

The two electrically insulating insulation elements 12a, 12b can be conventional boards in which, for example by means of a conventional etching process, conductor paths are formed in the form of copper bridges 13a, 13b. These are positioned on the sides of the insulation elements 12a, 12b facing the thermoelectric elements 9a-9e in such a way that they connect electrically with one another adjacent thermoelectric elements 9a-9e, along the extension direction E, of the same line branch 10a-10e or respectively of the same element row 8a-8e (cf. FIG. 1). Such boards can comprise one or several glass fibre reinforced plastic layer(s). The individual plastic layers of the board can have respectively layer thicknesses between 50 μm and 300 μm, so that a good thermal conductivity of the electric insulation elements 12a, 12b is ensured, without the necessary electrical insulation with respect to the battery cell 2 being endangered.

In order to achieve a good thermal coupling of the battery cell 2 to the thermoelectric module 6, an adapter layer 29 can be provided between the first insulation element 12a and the battery cell 2 which is to be temperature-controlled, which adapter layer comprises a heat-conducting and/or electrically insulating material. For example, the use of a thermoplastic plastic or of a film of a plastic is conceivable. With a suitable dimensioning of the adapter layer 29, it can be prevented that undesired intermediate spaces can form between the first insulation element 12a and the battery cell 2 which is to be temperature-controlled, which would reduce the thermal coupling of the battery cell 2 to the thermoelectric module 6.

According to FIG. 1, the electric switching elements 11a-11e can be provided on a side of the thermoelectric module 6 facing the temperature control structure 3. In this way, it can be largely or even entirely prevented that waste heat, generated by the electric switching elements 11a-11e during normal operation, is able to appreciably disturb the temperature control of the battery cell 2.

The thermoelectric module 1 also comprises temperature sensors 14a-14e for measuring the temperature of the battery cell 2 which is thermally coupled to the thermoelectric module 6. In the example scenario of FIG. 2, such a temperature sensor 14a-14e is provided in each element row 8a-8e. In simplified variants, however, such temperature sensors 14a-14e can also be dispensed with in one or more element rows 8a-8e. Vice versa, on the other hand, it is also conceivable to arrange more than only one temperature sensor 14a-14e in the individual element rows 8a-8e. In this case, a matrix-like arrangement of the temperature sensors 14a-14e can be expedient, in order to be able to determine the temperature in a spatially resolved manner. It basically applies here that with an increasing number of temperature sensors 14a-14e, the spatial resolution of the temperature measurement enabled by means of the temperature sensors 14a-14e can be increased.

The temperature sensors 14a-14e can be constructed as conventional temperature sensors such as for example PTC sensors, which are based on an electrical resistance measurement. Alternatively thereto, however, they can also be constructed as infrared sensors, by means of which the infrared radiation emitted by the battery cell 2 can be measured for determining temperature.

Furthermore, the temperature control device 1 comprises a control/regulation unit 15, cooperating both with the temperature sensors 14a-14e and also with the switching elements 11a-11e, which is illustrated roughly diagrammatically in FIG. 1, the illustration of which was dispensed with, however, in FIG. 2 for reasons of clarity. The control/regulation unit 15 is arranged/programmed in such a way that it switches the electric switching elements 11a-11e respectively as a function of the temperature measured by the temperature sensor 14a-14e of the same element row 8a-8e between the open and the closed state. For this, the temperature sensors 14a-14e are connected with the control/regulation unit 15 via suitable signal lines—in FIG. 1 only the signal line 30a associated with the temperature sensor 14a is shown for reasons of clarity—so that the current temperature value measured by the temperature sensor 14a can be transmitted to the control/regulation unit 15.

For activation of the electric switching elements 11a-11e, suitable electric control lines—again FIG. 1 shows only one such control line 31a for reasons of clarity—lead from the control/regulation unit 15 to the electric switching element 11a-11e. The regulation of the temperature control brought about by the temperature control device 1 can take place for example in such a way that the control/regulation unit 15 switches one or more switching elements 11a-11e into the closed state, in which the thermoelectric elements contribute to the temperature control of the battery cell 2, as soon as the temperature measured by the temperature sensor 14a-14e exceeds a predetermined first threshold, and is switched into the open state again, by the thermoelectric elements 9a-9e being switched off and not contributing to the cooling of the battery cell 2, as soon as the temperature measured by the temperature sensor 14a-14e falls below a second threshold. The second threshold can be equal to the first threshold here or, for realization of a hysteresis curve, can be smaller than the first threshold. The control/regulation unit 15 can be arranged/programmed in such a way that for the temperature sensors 14a-14e of a particular element row 8a-8e—in the simplest case a single temperature sensor 14a-14e per element row 8a-8e—and the electric switching element 11a-11e associated with these temperature sensors 14a-14e an individual temperature regulation is carried out. The temperature sensors 14a-14e, in connection with the common control/regulation unit 15 and the electric switching elements 11a-11e, permit a regulation of the heating- or respectively cooling power provided by the thermoelectric elements 9a-9e arranged in the element rows 8a-8e or respectively in the line branches 10a-10e, as a function of the temperature of the battery cell 2 coupled to these thermoelectric elements 9a-9e. This leads to an improved, homogenized temperature control of the battery cells 2 of the battery 23 by the thermoelectric elements 9a-9e.

The electric switching elements 11a-11e can comprise a semiconductor switch, in particular a thyristor. By means of such a semiconductor switch, the controllability of the electric switching element, necessary for the realizing of the temperature regulation explained above, can be ensured in a simple manner by the control/regulation unit 15. The use of a thyristor is recommended, because the latter is suitable to a considerable extent for controlling high electric currents which are necessary for the operation of thermoelectric elements 9a-9e.

FIG. 3 shows the temperature control device 1 in a cross-section along the section line III-III of FIG. 2. As already explained, not only a single fluid channel 16a is formed in the interior 4 of the temperature control structure 3, but rather an individual fluid channel 16a-16e is provided for each element row 8a-8e. The arrangement of the fluid channels 16a-16e in the temperature control structure 3 takes place in such a way that each fluid channel 16a-16e is thermally coupled to an element row 8a-8e associated with it.

Particularly expediently, the temperature control structure 3 can be constructed, as shown in FIG. 3, as a flat pipe 21, in which the fluid channels 16a-16e are formed by means of suitable dividing walls 22, and are separated fluidically from one another. The first conduit wall 5a lies here, with its side 7 facing the thermoelectric module 6, in a planar manner against the second insulation element 12b. Between the second electric insulation element 12b realized as a board and the first conduit wall 5a, a contact layer 28 of a heat-conducting adhesive can be provided. This leads to an advantageous thermal contact, over a large area, of the fluid channels 16a-16e of the flat pipe 21 with the thermoelectric module 6.

As FIG. 3 shows in addition, the fluid channels 16a-16e and the thermoelectric elements 9a-9e of the element rows 8a-8e extend respectively along the already established extension direction E, which in the example scenario is identical to the longitudinal direction L. With respect to the likewise already defined vertical direction H, which runs orthogonally both to the extension direction E or respectively longitudinal direction L and also to the transverse direction Q, each fluid channel 16a-16e therefore runs at a distance from the element row 8a-8e associated with it and parallel thereto.

Observing FIG. 1 again now, in which only the fluid channel 16a associated with the first element row 8a is shown, it will be seen that a valve element 17a essential to the invention is provided in the fluid channel 8a. This valve element is able to be switched between a closed position, shown in FIG. 1, in which it closes the fluid channel 17a, and an open position (not shown), in which it releases the fluid channel 16a in order for the fluid to flow through.

Preferably the valve element 17a-17e is arranged, in particular along the extension direction E, in the region of a respective actuator element 18a-18e. In this way, the desired coupling between valve element and actuator element can be realized particularly effectively.

According to FIG. 1, in the element row 8a which is associated with the fluid channel 16a having the valve element 17a, an electric actuator element 18a, cooperating with this valve element 17a, is also provided. This actuator element is, in turn, electrically connected to the thermoelectric elements 9a of the element row 8a and is connected electrically in series thereto. Particularly preferably, the actuator element 18a-18e is arranged electrically between two thermoelectric elements 9a-9e, therefore connected electrically in series between two thermoelectric elements 9a-9e. In this way, the required installation space for accommodating the respective actuator element 18a-18e can be kept small.

The electric actuator element 18a has two operating states and cooperates with the valve element 17a in such a way that in a first operating state it adjusts the valve element 17a into the open position. Accordingly, in a second operating state the actuator element 18a adjusts the valve element 17a into the closed position. For this, the actuator element 18a can comprise, for example, an electric coil element 19a, sketched only roughly diagrammatically in FIG. 1, which is connected electrically in series to the thermoelectric elements 9a of the element row 8a and in its first operating state is flowed through by electric current, but not in its second operating state. In a variant, also, an inverse relationship can be realized between the two operating states of the actuator element 18a and the two positions of the valve element 17a associated with the actuator element 18a.

Such a cooperation of actuator element 18a and valve element 17a makes it possible to couple the thermoelectric elements 9a of the element row 8a with the valve element 17a of the fluid channel 16a associated with this element row 8a. Therefore, the heating- or cooling power generated by the thermoelectric elements 9a can also be coupled with the heating- or respectively cooling power generated by the fluid flowing through the fluid channel 16a.

The switching of the actuator element 18a between its two operating states takes place in the example scenario of the figures indirectly by switching of the electric switching element 11a between the open and the closed state. Therefore, the fluid channel 16a, which is able to be “connected” by means of the valve element 17a, can be included into the temperature regulation explained above. In the closed state of the electric switching element 11a, an electric current flow is therefore possible through the thermoelectric elements 9a and therefore also through the electric actuator element 18a. The electric actuator element 18a is therefore then situated in its first operating state, in which it brings about an adjustment of the valve element 17a into the open position.

When the electric switching element 11a is switched into the open state, this leads to an interruption of the electric current flow through the thermoelectric elements 9a of the element row 8a and also through the electric actuator element 18a, so that the latter is switched into its first operating state. Consequently also the valve element 17a is also switched into the closed state, in which a flowing through of the fluid channel 16a with a fluid is prevented.

The opening of the fluid channel 16a by the valve element 17a, accompanying the first operating state of the actuator element 18a, can take place as follows in the case of the construction of the actuator element 18a as an electric coil element 19a, shown in the example: By the electric current flow through the coil element 19a, a magnetic field is generated, which in turn brings about an adjustment of the valve element 17a into the open position. For this, the valve element 17a can comprise a spring-elastic element 20a in the form of a leaf spring, which is prestressed against the closed position. When the spring-elastic element 20a has magnetic properties, the spring-elastic element 20a is moved into the open position with the aid of the magnetic field generated by the actuator element 18a.

A switching off of the electric current by means of the actuator element 18a by opening of the electric switching element 11a also results in a switching off of the magnetic field generated by the coil element 19a. The prestressed spring-elastic element then moves again back into the closed position, in which it closes the fluid channel 16a.

Of course, in a variant of the example, a prestressing of the spring-elastic element 20a into the open position is also conceivable.

In the scenario presented above, the electric actuator element 18a is constructed in such a way that it cooperates by means of magnetic coupling in a contactless manner with the valve element 17a for adjusting between the open and the closed position.

Alternatively to the construction as a spring-elastic element 20a, it is also conceivable to realize the valve element 17a in the form of a microvalve, which is then to be coupled electrically with the actuator element 18a.

The cooperation, explained above, of electric switching element 11a, electric actuator element 18a and valve element 17a within the scope of the invention presented here is not limited only to the first element row 8a and to the fluid channel 16a associated with this element row 8a; rather, it proves to be advantageous that at least two—particularly preferably all—element rows 8a-8a are provided with corresponding actuator elements 18a-18e, for example in the form of electric coil elements 19a-e, and in the corresponding fluid channels 16a-16e also respectively valve elements 17a-17e are provided for example in the form of spring-elastic components 20a-20e. In other words: The above explanations regarding the first element row 18a and the associated fluid channel 16a also apply mutatis mutandis for the remaining element rows 8b-8e and the corresponding fluid channels 16b-16e.

Particularly preferably, the respective electric switching element 11a-11e is arranged electrically between two thermoelectric elements 9a-9e. In this way, the required electric wiring outlay for the thermoelectric elements 9a-9e can be kept small.

The temperature control device 1 presented above is also suitable for the temperature control of a battery 23 with more than a single battery cell 2. The temperature control device 1 and at least two battery cells 2 as part of a battery 23 together form here a battery arrangement 24.

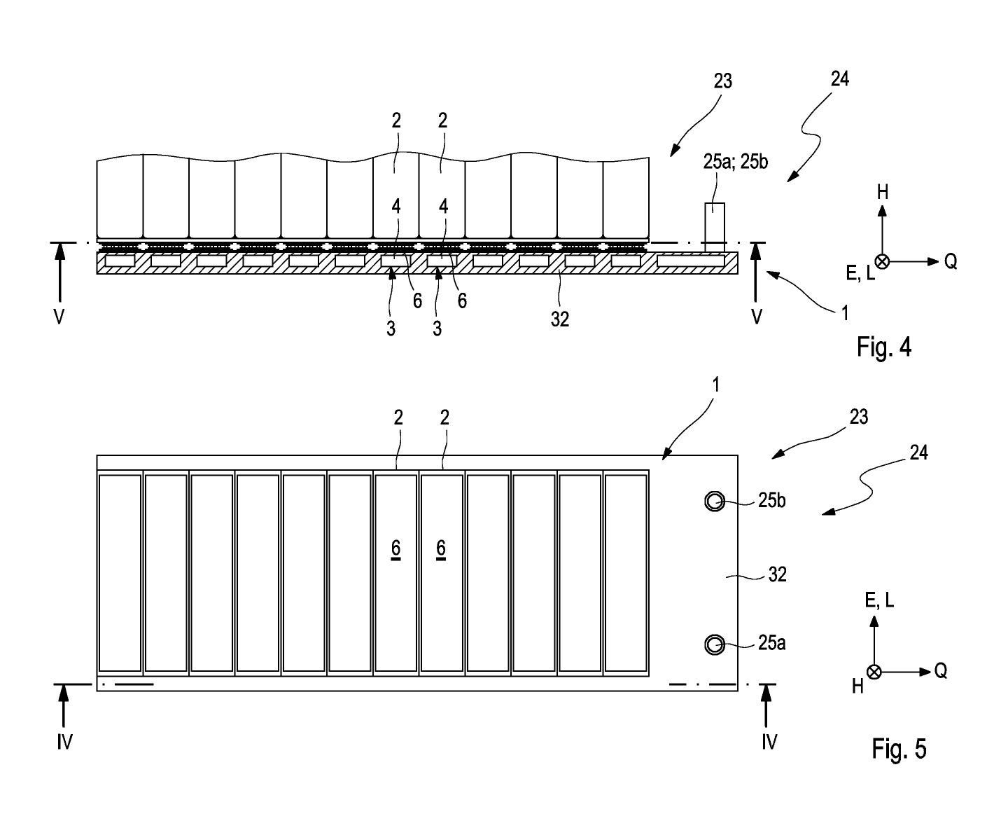

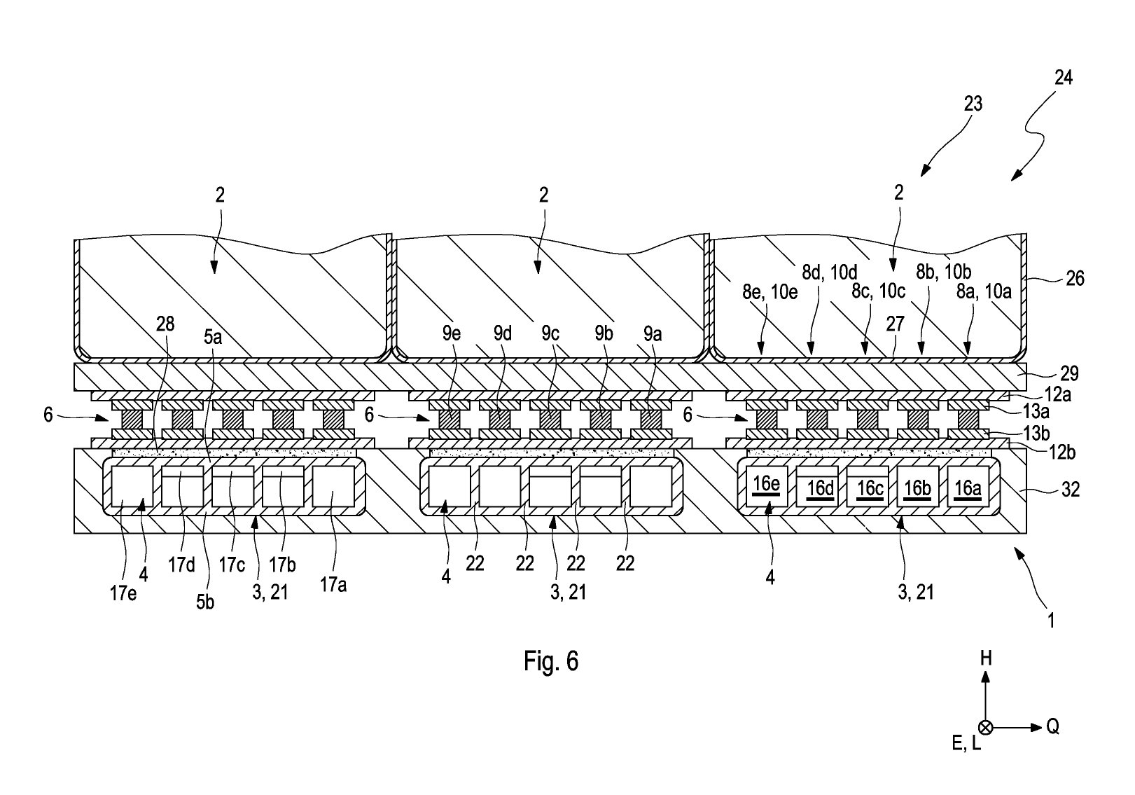

FIG. 4 shows such a battery arrangement 24 with, by way of example, twelve battery cells 2 which are to be temperature-controlled, which together form a battery 23, along a section line IV-IV of FIG. 5. FIG. 5 shows the battery arrangement 24 of FIG. 4 in a cross-section along the section line V-V of FIG. 4, FIG. 6 shows a detail illustration of FIG. 4.

It can be seen that the temperature control device 1 for each battery cell 2 comprises its own thermoelectric module 6. The thermoelectric modules 6, just like the battery cells 2, are arranged adjacently to one another along the transverse direction Q. Each battery cell 2 comprises a housing 26 with a housing wall 27, by means of which the battery cell 2 is connected mechanically and thermally with the thermoelectric module 6 associated with it.

It can be seen from FIGS. 4 and 5 that the flat pipe 21 for each thermoelectric module 6 has its own temperature control structure 3 with an interior 4. The interiors 4 can be connected with one another via suitable fluid line structures, for example via a collector 32 shown in FIG. 5, in such a way that the fluid is distributed to the interiors 4 of the temperature control structures 3 via a common inlet 25a provided on the collector 32, and leaves these interiors again via a common outlet 25b, likewise provided on the collector 32.

Possible technical realizations of the conduction of the flow through the collector 32, the flat pipes 21, the interiors 4 formed therein and the fluid channels 16a-16e, formed in turn in an interior 4, are familiar to the specialist in the art and are therefore not to be explained in further detail here.

It can be seen from the detail illustration of FIG. 6 that the three temperature control structures 3, shown by way of example in this figure and constructed as flat pipes 21, with their interiors 4, can be constructed respectively in an analogous manner to the temperature control device 1 according to FIGS. 1 to 3. Thus, FIG. 6 shows that in the respective interior 4 of each of the three flat pipes 21 five fluid channels 16a-16e are formed, which can be closed by a respective valve element 17a-17e. In FIG. 6, some valve elements 17a-e are illustrated by way of example in the closed position, and some in the open position.

As already mentioned, the modular design presented above permits the temperature control of a battery 23 with any desired number of battery cells 2. In a preferred variant of the battery arrangement 24 presented here, the battery 23 therefore comprises a plurality of battery cells 2.

In a particularly preferred variant of the battery arrangement 24, for each pair of a battery cell 2 and thermoelectric module 6 respectively at least one temperature sensor 14a-14e can be provided. This permits a particularly accurate temperature measurement of the temperature of the individual battery cells 2 and therefore also an individual temperature control of the battery cells 2. For this, the temperature regulation carried out by the control/regulation unit 15 can switch the switching elements 11a-11e of a respective thermoelectric module 6 as a function of the temperature between their closed and open state, which is able to be determined by the at least one temperature sensor 14a-14e associated with this thermoelectric module 6. The switching of the electric switching elements 11a-11e is then accompanied by a switching on and off of the element row 8a-8e having the respective switching element 11a-11e, and of the valve elements 17a-17e associated with the element rows 8a-8e via respective actuator elements 18a-18e.

1. A temperature control device for controlling a temperature of at least one energy supply unit, comprising:
a temperature control structure through which a fluid is flowable, the temperature control structure having at least one first conduit wall defining an interior;
at least one thermoelectric module arranged on the at least one first conduit wall on a side facing away from the interior;
wherein the at least one thermoelectric module at least two element rows each having at least two thermoelectric elements;
wherein the at least two element rows each extends along an extension direction;
wherein at least two fluid channels are provided in the temperature control structure, one fluid channel for each element row such that each fluid channel is thermally coupled to an associated element row; and
wherein in at least one fluid channel a valve is provided, the valve being adjustable between a closed position, in which the valve closes the fluid channel, and an open position, in which the valve releases the fluid channel in order for the fluid to flow through.

2. The temperature control device according to claim 1, wherein:
the element row associated with the at least one fluid channel with a valve is provided with an electric actuator therein, the electric actuator being electrically connected with the at least two thermoelectric elements of the associated element row; and
the electric actuator cooperates with the associated valve such that in a first operating state, the electric actuator adjusts the associated valve into the open position, and in a second operating state, the electric actuator adjusts the associated valve into the closed position.

3. The temperature control device according to claim 2, wherein:
the electric actuator is connected electrically in series to the at least two thermoelectric elements and
the electric actuator includes an electric coil element, which in the first operating state is flowed through by electric current, but not in the second operating state.

4. The temperature control device according to claim 2, wherein:
the electric actuator is constructed to cooperate with the associated valve in a contactless manner for adjusting between the open position and the closed position.

5. The temperature control device according to claim 1, wherein:
the valve includes a spring-elastic element prestressed against one of the open position and the closed position.

6. The temperature control device according to claim 1, wherein the valve is a microvalve.

7. The temperature control device according to claim 1, wherein:
the at least two thermoelectric elements of an element row are arranged substantially in a straight line along a longitudinal direction;
the at least two element rows are arranged adjacently to one another along a transverse direction running transversely to the longitudinal direction;
the thermoelectric elements of an element row are arranged along a vertical direction, which runs orthogonally to the longitudinal direction and to the transverse direction, between a first electrically insulating insulation element and a second electrically insulating insulation element; and
the second electrically insulating insulation element is arranged in the vertical direction between the at least two thermoelectric elements and the first conduit wall.

8. The temperature control device according to claim 1, wherein:
the temperature control structure is a flat pipe in which the at least two fluid channels are provided and which with a side facing the at least one thermoelectric module lies in a planar manner on the fluid channels; and
the at least two fluid channels each extends along the extension direction, and each fluid channel runs along a vertical direction at a distance from and substantially parallel to the associated element row.

9. The temperature control device according to claim 1, wherein:
in each element row associated with a fluid channel having a valve, an electric switch and an electric actuator are provided, the electric switch being able to be switched between a closed state and an open state;
the electric switch is connected electrically in series to the electric actuator provided in the associated element row, and to the at least two thermoelectric elements; and
the electric switch and the electric actuator cooperate such that a switching of the electric switch into the closed state brings about a switching of the electric actuator into a first operating state, in which the electric actuator adjusts the associated valve into the open position, and a switching of the electric switch into the open state brings about a switching of the electric actuator into a second operating state, in which the electric actuator adjusts the associated valve into the closed position.

10. The temperature control device according to claim 9, wherein the electric switch includes a semiconductor switch.

11. The temperature control device according to claim 9, wherein:
the at least one thermoelectric module includes at least one temperature sensor for measuring a temperature of a battery cell, which is able to be thermally coupled to the at least one thermoelectric module; and
a control unit is provided, the control unit cooperating with at least one switch and with the at least one temperature sensor, the control unit switching the at least one switch as a function of the temperature measured by the at least one temperature sensor between the open and the closed state.

12. The temperature control device according to claim 11, wherein:
for at least one element row, at least one temperature sensor is provided for measuring the temperature of a battery cell, which is able to be thermally coupled to the associated element row; and
the control unit is constructed in such a way that the switch associated with a particular element row is actuated by the control unit as a function of the temperature measured by the at least one temperature sensor.

13. The temperature control device according to claim 7, wherein:
the at least two thermoelectric elements are arranged substantially in a straight line adjacent to one another along the longitudinal direction; and
the at least two element rows are arranged adjacently to one another along the transverse direction.

14. A battery arrangement, comprising:
a temperature control device including:
a temperature control structure through which a fluid is flowable, the temperature control structure having at least one first conduit wall defining an interior;
at least one thermoelectric module arranged on the at least one first conduit wall on a side facing away from the interior;
wherein the at least one thermoelectric module has at least two element rows each having at least two thermoelectric elements;
wherein the at least two element rows each extends along an extension direction;
wherein at least two fluid channels are provided in the temperature control structure, one fluid channel for each element row such that each fluid channel is thermally coupled to an associated element row; and
wherein in at least one fluid channel a valve is provided, the valve being adjustable between a closed position, in which the valve closes the fluid channel, and an open position, in which the valve releases the fluid channel in order for the fluid to flow through; and
a battery including at least one battery cell, wherein the at least one battery cell on a side facing away from the temperature control structure is arranged on the temperature control structure.

15. The battery arrangement according to claim 14, wherein:
the at least one thermoelectric module includes at least two thermoelectric modules;
the at least one battery cell includes at least two battery cells; and
each battery cell includes a housing with a housing wall, by which the battery cell is connected mechanically and thermally to an associated one of the at least two thermoelectric modules.

16. The battery arrangement according to claim 14, wherein:
the battery includes a plurality of battery cells, and for each battery cell, one thermoelectric module is provided and connected mechanically and thermally to the associated battery cell.

17. The battery arrangement according to claim 16, further comprising at least one temperature sensor for each pair of a battery cell and associated thermoelectric module.

18. The battery arrangement according to claim 14, wherein the temperature control device includes:
a control unit; and
an electric switch in each element row associated with a fluid channel having a valve element;
wherein the control unit switches the electric switch between a closed state and an open state as a function of a temperature of the at least one battery cell.

19. The temperature control device according to claim 3, wherein the electric actuator is constructed to cooperate with the associated valve in a contactless manner for adjusting between the open position and the closed position.

20. A temperature control device comprising:
a temperature control structure through which a fluid is flowable, the temperature control structure having at least one first conduit wall defining an interior;
at least one thermoelectric module arranged on the at least one first conduit wall on a side facing away from the interior;
wherein the at least one thermoelectric module has at least two element rows each having at least two thermoelectric elements;
wherein the at least two element rows each extends along an extension direction;
wherein at least two fluid channels are provided in the temperature control structure, one fluid channel for each element row such that each fluid channel is thermally coupled to an associated element row;
wherein in each fluid channel a valve is provided, the valve being adjustable between a closed position, in which the valve closes the fluid channel, and an open position, in which the valve releases the fluid channel in order for the fluid to flow through;
wherein each element row is provided with an electric actuator and an electric switch;
wherein the electric actuator is electrically connected with the at least two thermoelectric elements of the associated element row, the electric actuator cooperating with the associated valve such that in a first operating state, the electric actuator adjusts the associated valve into the open position, and in a second operating state, the electric actuator adjusts the associated valve into the closed position; and
wherein the electric switch is switchable between a closed state and an open state, is connected electrically in series to the electric actuator and the at least two thermoelectric elements, and cooperates with the electric actuator such that a switching of the electric switch into the closed state brings about a switching of the electric actuator into the first operating state, and a switching of the electric switch into the open state brings about a switching of the electric actuator into the second operating state.
